(19) United States
(12) Patent Application Publication
(10) Pub. No.: US 2017/0361858 A1
(43) Pub. Date: Dec. 21, 2017

(54) GLASS TRANSPORTATION ASSEMBLY AND METHOD OF USE

(71) Applicant: Christopher Allen Gorman, Fort Lauderdale, FL (US)

(72) Inventor: Christopher Allen Gorman, Fort Lauderdale, FL (US)

(21) Appl. No.: 15/187,908

(22) Filed: Jun. 21, 2016

(51) Int. Cl. B62B 3/10; F16M 11/42; B62B 3/04

(52) U.S. Cl. CPC B62B 3/10; B62B 3/04; F16M 11/42

(57) ABSTRACT

A glass transportation assembly with a plurality of wheels, a lower glass-resting portion having a frame with the plurality of wheels coupled thereto, and an upper glass-resting portion having an upright member defining a glass-resting surface substantially orthogonal to a glass-resting surface on the frame having a glass-resting surface. The frame has a first and second plurality of discontinuous strap holders that are substantially aligned with one another and each define a channel with channel openings oriented in respective directions facing the rear and front ends of the frame, wherein the channel and channel openings sized to receive a 4″ strap. The first and second plurality of discontinuous strap holders are disposed at respective left and right ends of the frame for lifting and transportation.

### FIELD OF THE INVENTION

The present invention relates generally to devices and methods to transport glass and, more particularly, relates to devices and methods of transporting sheets of glass for windows and other construction purposes.

### BACKGROUND OF THE INVENTION

Using glass, whether for windows, doors, or other applications, is prevalent in most buildings and other structures. Generally, most of these pieces or “sheets” of glass are framed with metal or other material for ease of installation and transportation. With or without the frame, however, they are generally very heavy and prone to damage if struck by outside objects. As such, most of these sheets of glass are transported at the manufacturing or retail facility using assemblies similar to those shown in FIGS. 1 and 2. These assemblies are also used to transport the sheets of glass at the construction or installation site. The process of transporting the glass from the manufacturing/retail facility to the construction site typically includes the arduous and time-intensive task of loading the sheets of glass from the glass-holding apparatus at the manufacturing facility onto a vehicle picking up those sheets of glass for transportation, unloading those sheets of glass from the vehicle at the construction site, unloading the glass onto another glass-holding apparatuses at the construction site, and then maneuvering those sheets of glass at the construction site for placement on the building structure.

Those known apparatuses do not provide users the ability effectively and efficiently transport sheets of glass in a safe and quick manner. Specifically, with reference to one known apparatus shown in FIG. 1, the apparatus has a lower glass-resting section 100 where the glass is supported and an upper glass-resting section 102 where an upper end 104 of the glass is supported. These apparatuses, along with the glass, are either moved manually by users, which is prone to causing injury to the laborer, or moved with the assistance of machinery such as tow tractors or forklifts. Regardless, it takes significant time and energy by the user to move and/or transport the glass.

With reference now to FIG. 2, another known apparatus for transporting glass is shown. This type of apparatus suffers from many of the disadvantages described above with reference to apparatus shown in FIG. 1, but it also has a size/height limitation on the glass to which it transports. More specifically, there are two angled upright members 200 consisting of the upper glass-resting section 202, wherein the apparatus is specifically designed to transport glass on each side of the apparatus. As will be appreciated by those of skill in the art, this type of apparatus will only accommodate glass of a specific, and limited, height/length/width because at some point the two pieces of glass will be impacted with one another as they extend upwardly on the upper glass-resting section 202. This configuration not only leads to an increase potential in damaging the glass, but it also provides an unsafe working condition for the user and provides maneuverability restrictions of the apparatus in order to compensate for the height restriction.

Therefore, a need exists to overcome the problems with the prior art as discussed above.

### SUMMARY OF THE INVENTION

The invention provides a glass transportation apparatus and method of use that overcomes the hereinafore-mentioned disadvantages of the heretofore-known devices and methods of this general type and that provides users an easy, effective, efficient, and safe way to transport glass all the way from the retail facility, to the construction site, and up until the last step of the user installing the piece of glass.

With the foregoing and other objects in view, there is provided, in accordance with the invention, a glass transportation assembly that includes a plurality of wheels operably configured to roll on a ground surface with movement of the glass transportation assembly, a lower glass-resting portion having a frame with the plurality of wheels coupled to a bottom surface of the frame, and an upper glass-resting portion having an upright member defining a glass-resting surface substantially orthogonal to the glass-resting surface of the lower glass-resting portion. The frame of the lower glass-resting portion has a rear end of the frame, a front end of the frame opposing the rear end, a left end of the frame, and a right end of the frame opposing the left end of the frame. The frame also includes a first plurality of discontinuous strap holders, each defining a channel with channel openings oriented in respective directions facing the rear and front ends of the frame, wherein the channel and channel openings sized to receive a 4 inch strap, are substantially aligned with one another, and disposed at the left end of the frame. The frame also includes a second plurality of discontinuous strap holders, each defining a channel with channel openings oriented in respective directions facing the rear and front ends of the frame, wherein the channel and channel openings sized to receive a 4″ strap, are aligned with one another, and disposed at the right end of the frame. The frame also includes a glass-resting surface.

In accordance with a further feature of the present invention, one of both the first and second plurality of discontinuous strap holders is disposed at the rear end of the frame and another of both the first and second plurality of discontinuous strap holders is disposed at the front end of the frame.

In accordance with yet another feature of the present invention, the first and second plurality of discontinuous strap holders are coupled to the bottom surface of the frame.

In accordance with an additional feature of the present invention, the first and second plurality of discontinuous strap holders are coupled to, and extend downwardly away from, the bottom surface of the frame.

In accordance with another feature, an embodiment of the present invention includes the frame further comprising a terminal edge at the rear end, a terminal edge at the front end, a terminal edge at the left end of the frame, and a terminal edge at the right end, wherein one of the first plurality of discontinuous strap holders is substantially adjacent to the terminal edge of the rear end of the frame and terminal edge of the left end of the frame and another of the first plurality of discontinuous strap holders is substantially adjacent to the terminal edge of the front end of the frame and terminal edge of the left end of the frame.

In accordance with a further feature of the present invention, one of the second plurality of discontinuous strap holders is substantially adjacent to the terminal edge of the rear end of the frame and terminal edge of the right end and another of the second plurality of discontinuous strap holders is substantially adjacent to the terminal edge of the front end of the frame and terminal edge of the right end.

In accordance with a further feature of the present invention, the upper glass-resting portion of the glass transportation assembly has a first end coupled to the terminal edge of the frame and the upright member of the upper glass-resting portion extends upwardly in a direction away from the from the glass-resting surface.

In accordance with yet another feature of the present invention, the glass-resting surface of the frame spans and slopes downwardly in direction front end of the frame to the rear end of the frame.

In accordance with yet another feature of the present invention, the glass-resting surface is substantially planar.

In accordance with an additional feature of the present invention, the frame is of a metallic material.

In accordance with another feature, an embodiment of the present invention also includes the first and second plurality of discontinuous strap holders each having a space between one another of at least approximately 2 inches.

In accordance with a further feature of the present invention, the first plurality of discontinuous strap holders define a first distance between one another and the second plurality of discontinuous strap holders also define a second distance between one another, wherein the first and second distances between the respective strap holders of an equal length.

In accordance with yet another feature of the present invention, the frame is of a rectangular shape defining four corners, wherein each of the four corners respectively have one of the first and second plurality of discontinuous strap holders.

In accordance with the present invention, a method of transporting glass sheets that includes the steps of (1) providing a glass transportation assembly having a lower glass-resting portion including a frame with a glass-resting surface and a first and a second plurality of discontinuous strap holders and having an upper glass-resting portion with an upright member defining a glass-resting surface substantially orthogonal to the glass-resting surface, wherein each of the respective first and second plurality of discontinuous strap holders are substantially aligned with one another and define a channel with channel openings oriented in respective directions facing a rear end of the frame and a front end of the frame, (2) providing at least one piece of construction material, (3) providing at least one crane strap, (4) placing the at least one piece of construction material on the glass-resting surface of the frame, (5) inserting the at least one crane strap through the channel and channel openings of each of the first and a second plurality of discontinuous strap holders; and (6) transporting the glass transportation assembly and the at least one piece of construction material by applying a lifting force, through a lifting assembly, to the at least one crane strap.

In accordance with another feature, an embodiment of the present invention also includes fastening the sheet of glass to the upright member using a glass-retention strap or transporting the glass transportation assembly and the at least one piece of construction material by applying the lifting force at corners of the frame, wherein the corners of the frame respectively correspond to a location of the first and second plurality of discontinuous strap holders.

Although the invention is illustrated and described herein as embodied in a glass moving apparatus and method of use, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the apparatus extending from the lower glass-resting section to the upper glass-resting section.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective, rear, view of a known glass-transportation apparatus;

FIG. 2 is a perspective, side, view of another known glass-transportation apparatus;

FIG. 3a is a perspective view of a glass-transportation apparatus being maneuvered by a lift in accordance with one embodiment of the present invention;

FIG. 3b is a close-up view of one of a plurality of strap supports of the glass-transportation apparatus of FIG. 3a with a strap interposed therein;

FIG. 4 is an elevational front view of the glass-transportation apparatus of FIG. 3a; and

FIG. 5 is a process flow diagram depicting a method of transporting glass sheets with the apparatus of FIG. 3a in accordance with the present invention.

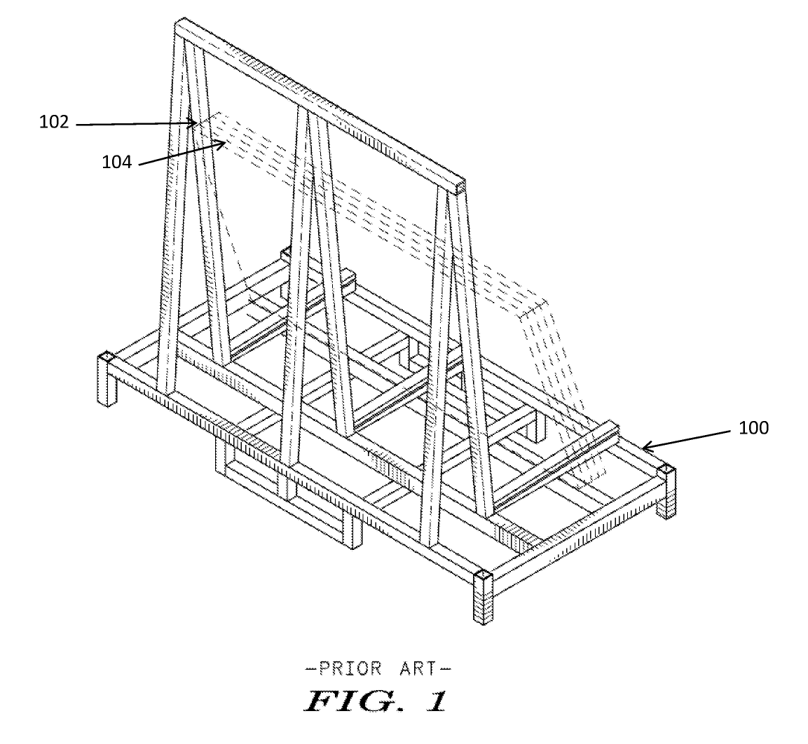

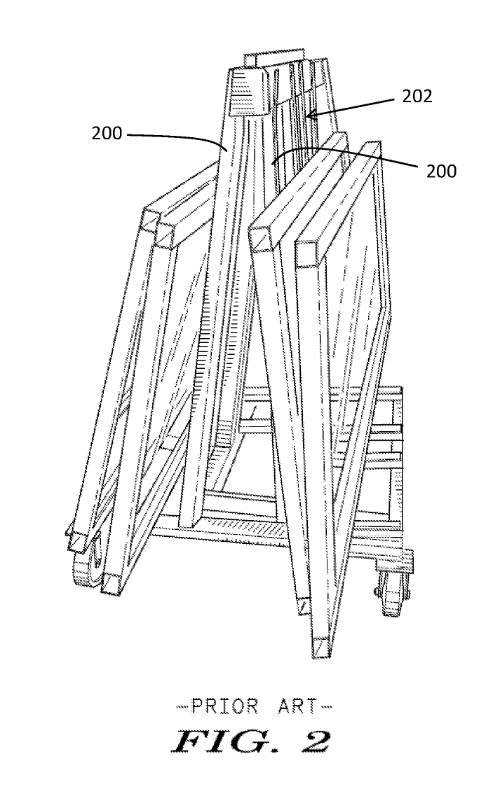

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient glass-transportation apparatus and method of use that provides users an effective and safe way to transport one or more pieces of construction material(s), particularly glass sheets, from a point-of-sale or storage location all the way through installation at a construction or installation location.

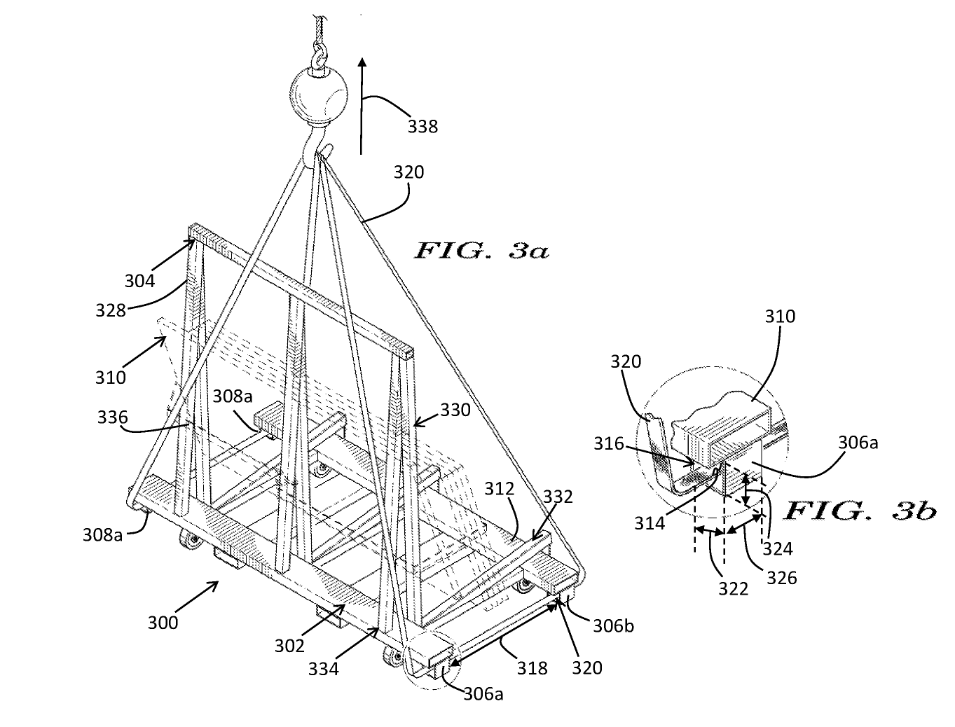

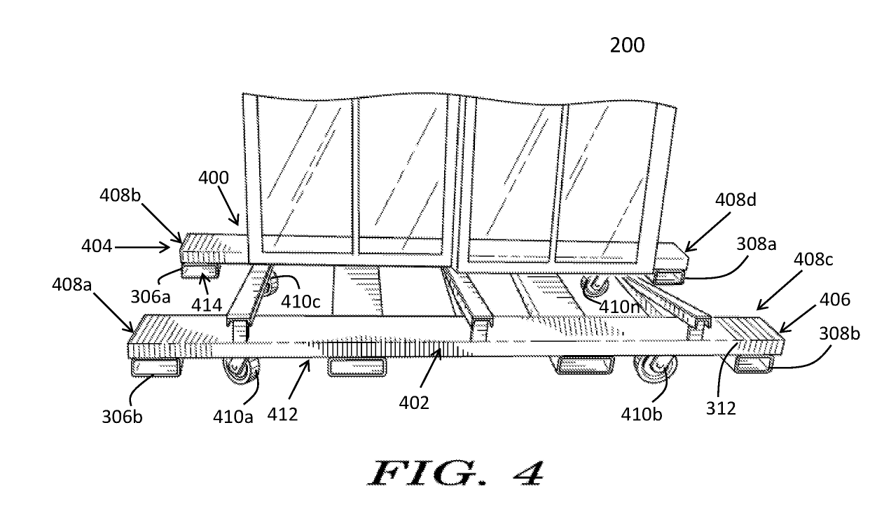

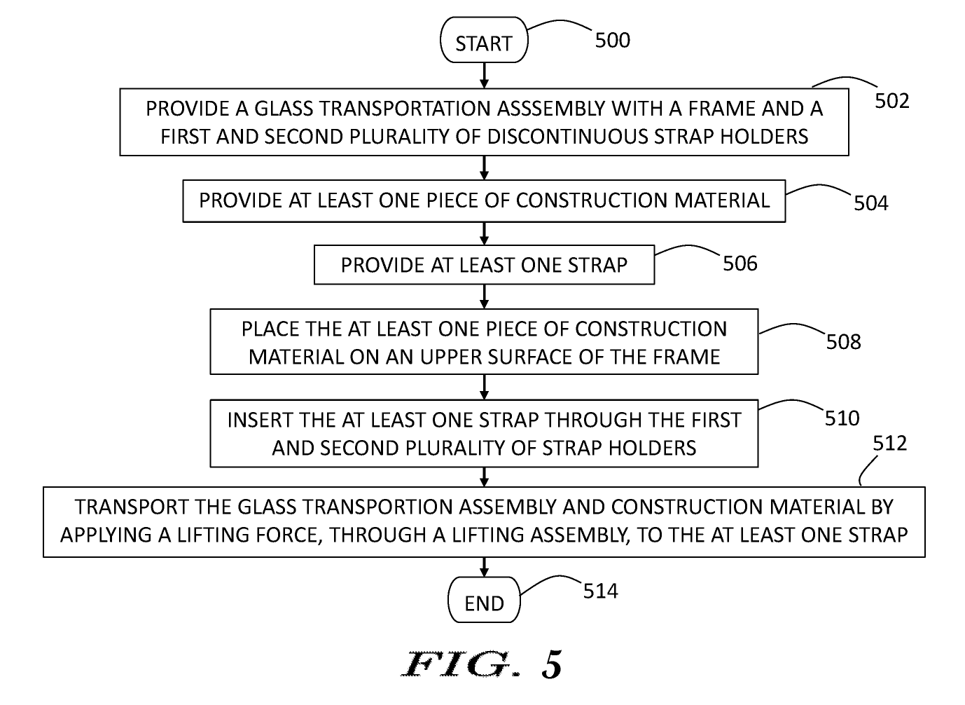

Referring now to FIGS. 3a-b and FIG. 4, one embodiment of the present invention is shown. FIGS. 3a-b and FIG. 4 show several advantageous features of the present invention, but, as will be described below, the invention can be provided in several shapes, sizes, combinations of features and components, and varying numbers and functions of the components. FIGS. 3a-b and FIG. 4 will be described in conjunction with the process flow chart of FIG. 5. Although FIG. 5 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 5 for the sake of brevity. In some embodiments, some or all of the process steps included in FIG. 5 can be combined into a single process.

The process begins as step 500 and then proceeds to step 502 of providing a glass transportation assembly 300. The first example of the glass transportation assembly 300, as shown in FIGS. 3a-b and FIG. 4, includes a lower glass-resting portion 302 and an upper glass-resting portion 304. While referred to as a “glass resting portion,” those of skill in the art will appreciate that in reading this disclosure said term does not require glass, nor having any glass that “rests”; rather, it said term is being used for identification purposes. Advantageously, the lower glass-resting portion 302 employs a frame 312 that includes a first plurality of discontinuous strap holders 306a-b and a second plurality of discontinuous strap holders 308a-b for transporting and maneuvering the glass transportation assembly 300 and any construction materials 310, particularly glass, it carries.

The frame 312 can be seen having a rear end 400, a front end 402 opposing the rear end 400, a left end 404, and a right end 406 opposing the left end 404. The frame 312 can also be seen having a glass-resting surface 332 where the piece of glass 310 is supported. In one embodiment, to effectuate an equal distribution of force in transport on the frame 312, the frame 312 may also be formed in lattice-based configuration (as exemplified in FIG. 4), in a rectangular shape with four corners 408a-d, wherein each of the strap holders 306a-b are disposed. The frame 312 is preferably of a metallic material, e.g., steel, having a tensile strength of approximately 43 ksi. In other embodiments, the frame 312 may be in another geometric shape and the material may vary in accordance with construction material, or “load,” it carries and transports. To effectuate efficient and quick transportability and maneuverability of the assembly 300, a plurality of wheels 410a-n are coupled to a bottom surface 412 of the frame 312 and are operably configured to roll on a ground surface with movement of the glass transportation assembly 300.

The first and second plurality of discontinuous strap holders 306a-b, 308a-b can be seen defining a channel 314 with channel openings 316, 414 oriented in respective directions facing the rear and front ends 400, 402 of the frame 312. The strap holders 306a-b, 308a-b are “discontinuous” in that there is a gap (illustrated with an arrow 318) separating each of the strap holders in the first and second plurality of strap holders 306a-b, 308a-b. Being discontinuous, the user is able to effectively and quickly route one or more straps through the strap holders 306a-b, 308a-b. In one embodiment, the gap or space 318 between each of the strap holders 306a-b is at least approximately 2 inches. Further, the gap or space between each of the strap holders 308a-b may also be equal to the first gap 318, or at least approximately 2 inches. In other embodiments, the space 318 may vary.

Each respective strap holders 306a-b, 308a-b are also substantially aligned with one another so that one or more of their respective openings face one another. For example, with brief reference to FIGS. 3a and FIG. 4, the opening 316 defined by the strap holder 306b and the opening 414 defined by the strap holder 306a can been seen substantially aligned, or facing another to effectuate a quick threading of the strap 320 through the strap holders 306a-b, 308a-b.

The channel 314 and channel openings 316 are preferably sized, in width (represented by arrow 322), to receive a 4″ strap, similar to the strap 320 shown in FIGS. 3a-b. The height (represented by arrow 324) may be approximately 2 inches and the length (represented by arrow 326) may be approximately 6 inches. In other embodiments, widths 322, heights 324, and lengths 326 of the strap holders 306a-b, 308a-b may vary outside of the above dimensions.

Beneficially, for a more balanced force distribution, the first plurality of strap holders 306a-b can be seen disposed at the left end 404 of the frame 312, while the second plurality of strap holders 306a-b can be seen disposed at the right end 404 of the frame 312. The strap holders 306a-b, 308a-b may be generally of a rectangular shape in one embodiment. In other embodiments, the trap holders 306a-b, 308a-b may be of another shape sufficient to hold and retain the one or more straps 320. The first and second plurality of discontinuous strap holders 306a-b, 308a-b may be coupled to the bottom surface 412 of the frame 312 and, more particularly, may extend downwardly away from, the bottom surface 412 of the frame 312 so as to not affect the egress and entry of the construction material 310.

The upper glass-resting portion 304 can be seen having one or more upright, i.e., vertical, members 328 defining a glass-resting surface 330 substantially orthogonal, or 90°+/−15°, to the glass-resting surface 332. The upper glass-resting portion 304 may also have a first end 334 coupled to a terminal edge (as described below) of the frame 312 and the upright member 328 extends upwardly in a direction away from the from the glass-resting surface 332. To facilitate in the retention of the construction material(s), the glass-resting surface 332 may span and slope downwardly in direction front end 402 of the frame 312 to the rear end 400 of the frame 312 as shown in FIG. 3a and FIG. 4. Furthermore, to also facilitate in the retention of the construction material(s), the glass-resting surfaces 330, 332 may also be substantially planar or flat.

In one embodiment, the frame 312 includes a terminal edge at the rear end 400, a terminal edge at the front end 402, a terminal edge at the left end 404, and a terminal edge at the right end 406, wherein respective strap holders 306a-b, 308a-b are disposed substantially adjacent, i.e., within approximately 2-3 inches, to said terminal edges as shown in FIG. 4.

The process shown in FIG. 5 moves from step 502 of providing the glass transportation assembly 300 to step 504 of providing at least one piece of construction material 310, e.g., a sheet or piece of glass. As used herein, the sheet or piece of glass shall be construed broadly and will not limit the scope of this invention to construction materials such as planks, doors, framed and unframed windows, and other construction materials. Next, the process continues to step 506 of providing at least one strap or sometimes referred to a “crane strap.” Crane strap(s) are broadly construed as meaning any strap, typically of a fabric or composite material, used in conjunction with a lifting or ratcheting assembly and a panel or pallet.

Next, the process continues to step 508 of placing the at least one piece of construction material 310 on the glass-resting surface 332 of the frame 312 or glass-resting surface 330 of the upright member 328. The user may then strap or fasten the at least one piece of construction material 310 to the one or more upright member(s) 328 using, for example, another strap 336. Next, the process continues to step 510 of inserting the at least one crane strap 320 through the channels and channel openings of each of the first and a second plurality of discontinuous strap holders 306a-b, 308a-b as shown in FIG. 3a.

Lastly, the process continues to step 512 of transporting the glass transportation assembly 300 and the at least one piece of construction material 310 by moving the glass transportation assembly 300 via the wheels 410a-n or applying a lifting force (depicted with arrow 338), through a lifting assembly (not shown), to the at least one crane strap 320. The lifting assembly transports the glass transportation assembly 300 and the at least one piece of construction material 310 by applying a lifting force through the one or more straps 320, that is transferred to the frame 312. The lifting assembly may be a crane, a truck, a sports utility vehicle, or any other machine suitable for transporting the glass transportation assembly 300 and the at least one piece of construction material 310 as would be appreciated by one of ordinary skill in the art.

The amount of lifting force applied by the lifting assembly may vary depending on the weight of the glass transportation assembly 300 and the at least one piece of construction material 310. Lifting the glass transportation assembly 30 and the at least one piece of construction material 310 necessarily entails applying a force away from and greater than the combined weight of the glass transportation assembly 300 and the at least one piece of construction material 310. As such, the user is able to effectively store and transport construction materials 310, particularly glass, at the manufacturing plant, and then maneuver and transport said assembly 300 and construction material 310 to the construction site, and ultimately to its desired location. The process terminates in step 514.

In one exemplary application of transporting the glass transportation assembly 300 to the installation site, the assembly 300, with the construction material 310, is lifted to a raised platform typically found on buildings that are being renovated. These elevated one or more platforms project outside of the building on one or more floors of the building, similar to a cantilever beam, are supported with brace that extends from an upper surface of the platform—at an end opposite to the an extending outside of the building—to a ceiling or upper surface of the particular floor the platform is located, and are used to support the assembly 300 as it is delivered to the platform and wheeled inside to the particular location of installation. Other applications of using the assembly 300 are contemplated and within the skill of an ordinary person in the relevant art.

In light of the above, a glass transportation assembly and method of use is disclosed that provides users an effective and safe way to transport one or more pieces of construction material(s), particularly glass sheets, from a point-of-sale or storage location all the way through installation at a construction or installation location.

1. A glass transportation assembly comprising:
a plurality of wheels operably configured to roll on a ground surface with movement of the glass transportation assembly;
a lower glass-resting portion having a frame with the plurality of wheels coupled to a bottom surface of the frame, the frame including:
a rear end of the frame, a front end of the frame opposing the rear end, a left end of the frame, and a right end of the frame opposing the left end of the frame;
a first plurality of discontinuous strap holders, each:
defining a channel with channel openings oriented in respective directions facing the rear and front ends of the frame, the channel and channel openings sized to receive a four-inch strap;
substantially aligned with one another; and
disposed at the left end of the frame;
a second plurality of discontinuous strap holders, each:
defining a channel with channel openings oriented in respective directions facing the rear and front ends of the frame, the channel and channel openings sized to receive a four-inch strap;
aligned with one another; and
disposed at the right end of the frame; and
a glass-resting surface;
an upper glass-resting portion having an upright member defining a glass-resting surface, the upper glass-resting portion being substantially orthogonal to the glass-resting surface of the lower glass-resting portion; and
a glass securing member having a first end mechanically coupled to the upper glass-resting portion, a second end mechanically coupled to the upper glass-resting portion, and substantially surrounding a mid-section of the upper glass-resting portion.

2. The glass transportation assembly according to claim 1, wherein:
one of both the first and second plurality of discontinuous strap holders is disposed at the rear end of the frame and another of both the first and second plurality of discontinuous strap holders is disposed at the front end of the frame.

3. The glass transportation assembly according to claim 2, wherein:
the first and second plurality of discontinuous strap holders are coupled to the bottom surface of the frame.

4. The glass transportation assembly according to claim 3, wherein:
the first and second plurality of discontinuous strap holders are coupled to, and extending downwardly away from, the bottom surface of the frame.

5. The glass transportation assembly according to claim 4, wherein the frame further comprises:
a terminal edge at the rear end, a terminal edge at the front end, a terminal edge at the left end of the frame, and a terminal edge at the right end, wherein one of the first plurality of discontinuous strap holders is substantially adjacent to the terminal edge of the rear end of the frame and terminal edge of the left end of the frame and another of the first plurality of discontinuous strap holders is substantially adjacent to the terminal edge of the front end of the frame and terminal edge of the left end of the frame.

6. The glass transportation assembly according to claim 5, wherein:
one of the second plurality of discontinuous strap holders is substantially adjacent to the terminal edge of the rear end of the frame and terminal edge of the right end and another of the second plurality of discontinuous strap holders is substantially adjacent to the terminal edge of the front end of the frame and terminal edge of the right end.

7. The glass transportation assembly according to claim 6, wherein:
the upper glass-resting portion of the glass transportation assembly has a first end coupled to the terminal edge of the frame and the upright member of the upper glass-resting portion extends upwardly in a direction away from the glass-resting surface.

8. The glass transportation assembly according to claim 1, wherein:
the glass-resting surface of the frame spans and slopes downwardly in direction front end of the frame to the rear end of the frame.

9. The glass transportation assembly according to claim 1, wherein:
the glass-resting surface is substantially planar.

10. The glass transportation assembly according to claim 1, wherein the frame further comprises:
a plurality of frame members in a lattice-based configuration.

11. The glass transportation assembly according to claim 1, wherein:
the frame is of a metallic material.

12. The glass transportation assembly according to claim 1, wherein the first and second plurality of discontinuous strap holders each further comprise:
a space between one another of at least approximately two-inches.

13. The glass transportation assembly according to claim 1, wherein:
the first plurality of discontinuous strap holders define a first distance between one another; and
the second plurality of discontinuous strap holders define a second distance between one another, the first and second distances between the respective strap holders of an equal length.

14. The glass transportation assembly according to claim 1, wherein:
the frame is of a rectangular shape defining four corners, each of the four corners respectively having one of the first and second plurality of discontinuous strap holders.

15. A method of transporting glass sheets comprising the steps of:
providing a glass transportation assembly having a lower glass-resting portion including a frame with a glass-resting surface and a first and a second plurality of discontinuous strap holders and having an upper glass-resting portion with an upright member defining a glass-resting surface substantially orthogonal to the glass-resting surface, wherein each of the respective first and second plurality of discontinuous strap holders are substantially aligned with one another and define a channel with channel openings oriented in respective directions facing a rear end of the frame and a front end of the frame;
providing at least one piece of construction material;
providing at least one crane strap;
placing the at least one piece of construction material on the glass-resting surface of the frame;
inserting the at least one crane strap through the channel and channel openings of each of the first and a second plurality of discontinuous strap holders; and
transporting the glass transportation assembly and the at least one piece of construction material by applying a lifting force, through a lifting assembly, to the at least one crane strap.

16. The method of transporting glass sheets according to claim 15, wherein:
the first and second plurality of discontinuous strap holders each define a channel with channel openings oriented in respective directions facing a rear end and a front end of the frame, the first plurality of discontinuous strap holders disposed at a left end of the frame and the second plurality of discontinuous strap holders disposed at a right end of the frame.

17. The method of transporting glass sheets according to claim 16, wherein:
one of both the first and second plurality of discontinuous strap holders is disposed at a rear end of the frame and another of both the first and second plurality of discontinuous strap holders is disposed at a front end of the frame.

18. The method of transporting glass sheets according to claim 17, wherein:
the at least one piece of construction material is a sheet of glass and the glass-resting surface is substantially planar.

19. The method of transporting glass sheets according to claim 15, further comprising:
fastening the sheet of glass to the upright member using a glass-retention strap.

20. The method of transporting glass sheets according to claim 15, further comprising:
transporting the glass transportation assembly and the at least one piece of construction material by applying the lifting force at corners of the frame, wherein the corners of the frame respectively correspond to a location of the first and second plurality of discontinuous strap holders.
